(19) United States
(12) Patent Application Publication
(10) Pub. No.: US 2026/0093577 A1
(43) Pub. Date: Apr. 2, 2026

(54) CONTROLLER AND MEMORY SYSTEM

(71) Applicant: SK hynix Inc., Gyeonggi-do (KR)

(72) Inventor: Chang Hyun PARK, Gyeonggi-do (KR)

(21) Appl. No.: 19/039,156

(22) Filed: Jan. 28, 2025

(30) Foreign Application Priority Data
Oct. 2, 2024 (KR) 10-2024-0133450

(51) Int. Cl. G06F 11/10; G06F 11/14; G06F 11/273

(52) U.S. Cl. CPC G06F 11/1016; G06F 11/1441; G06F 11/273

(57) ABSTRACT

In embodiments of the present disclosure, when a memory which has a defect (failed memory) occurs in a memory system including a plurality of memories, detect read operations are performed in a state in which each of the plurality of memories is sequentially excluded in rotation, and a read operation is controlled by setting a memory which is excluded in a case where the number of corrected errors is smallest during the detect read operations, as an error memory. Therefore, a failed memory may be accurately detected, and even when a failed memory occurs among the plurality of memories, error correction performance may be improved to improve the operational performance of the memory system.

### CROSS-REFERENCE TO RELATED APPLICATION

The present application claims priority under 35 U.S.C. § 119(a) to Korean Patent Application No. 10-2024-0133450 filed on Oct. 2, 2024, which is incorporated herein by reference in its entirety.

### BACKGROUND

### 1. Technical Field

Embodiments of the present disclosure generally relate to a controller and a memory system.

### 2. Related Art

A memory system may include at least one memory which stores data. The memory system may include a controller which controls the operation of the at least one memory. The controller may control a write operation or a read operation for the memory, and may correct an error that occurs during the read operation.

As the case may be, the memory system may include a plurality of memories. The memory system may read data from the plurality of memories and provide the data to an external device. At least one of the plurality of memories may fail, and a problem may arise in that, when error correction by the controller is not possible, the performance of the memory system may deteriorate.

### SUMMARY

Various embodiments of the present disclosure are directed to providing measures for improving the performance and reliability of a memory system including a plurality of memories by increasing the accuracy of detecting a memory which has a defect and increasing the performance of correcting an error caused due to failure of a memory in the memory system.

In an embodiment, a memory system may include: a plurality of memories; and a controller configured to perform a data read operation of reading data having a unit size from each of the plurality of memories, perform, when an uncorrectable error occurs during the data read operation, detect read operations, each detect read operation reading data having the unit size from each of remaining memories excluding at least one memory selected in rotation among the plurality of memories, check numbers of errors corrected in each of the detect read operations, and set, as an error memory, at least one memory excluded during a detect read operation in which a smallest number of errors is corrected, among the detect read operations.

In an embodiment, a memory system may include: a plurality of memories; and a controller configured to perform a data read operation on remaining memories excluding an error memory, among the plurality of memories, perform a test read operation on the error memory, and sequentially perform detect read operations on memories other than one memory selected in rotation among the plurality of memories when a number of errors detected in the test read operation is smaller than a preset number.

In an embodiment, a controller may include: a control circuit configured to perform a first read operation on a plurality of memories; and an error correction circuit configured to correct an error which occurs in the first read operation, wherein the control circuit is configured to sequentially perform second read operations on memories excluding at least one memory selected in rotation among the plurality of memories when an uncorrectable error occurs in the first read operation, and set, as an error memory, a memory which is excluded in a second read operation in which a smallest number of errors is corrected, among the second read operations.

According to the embodiments of the present disclosure, the accuracy of a method of detecting a memory which has a defect among a plurality of memories included in a memory system may be increased, and the operational reliability of the memory system may be improved through control of a read operation after detecting the memory which has a defect.

### BRIEF DESCRIPTION OF THE DRAWINGS

FIG. 1 is a diagram illustrating an example of the schematic configuration of a memory system according to embodiments of the present disclosure.

FIG. 2 is a diagram illustrating an example of the configuration of a controller included in the memory system according to the embodiments of the present disclosure and an example of a method of performing a data read operation in the memory system.

FIGS. 3A to 3C are diagrams illustrating examples of a method of performing a detect read operation in the memory system according to the embodiments of the present disclosure.

FIG. 4 is a diagram illustrating an example of a method of performing a data read operation after setting an error memory in the memory system according to the embodiments of the present disclosure.

FIG. 5 is a diagram illustrating an example of a method of performing a test read operation after setting an error memory in the memory system according to the embodiments of the present disclosure.

FIG. 6 is a diagram illustrating an example of a method of performing a detect read operation after performing a test read operation in the memory system according to the embodiments of the present disclosure.

FIG. 7 is a diagram illustrating an example of a method in which the memory system according to the embodiments of the present disclosure sets an error memory.

FIG. 8 is a diagram illustrating an example of a method in which the memory system according to the embodiments of the present disclosure operates after setting an error memory.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly”or “immediately”is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

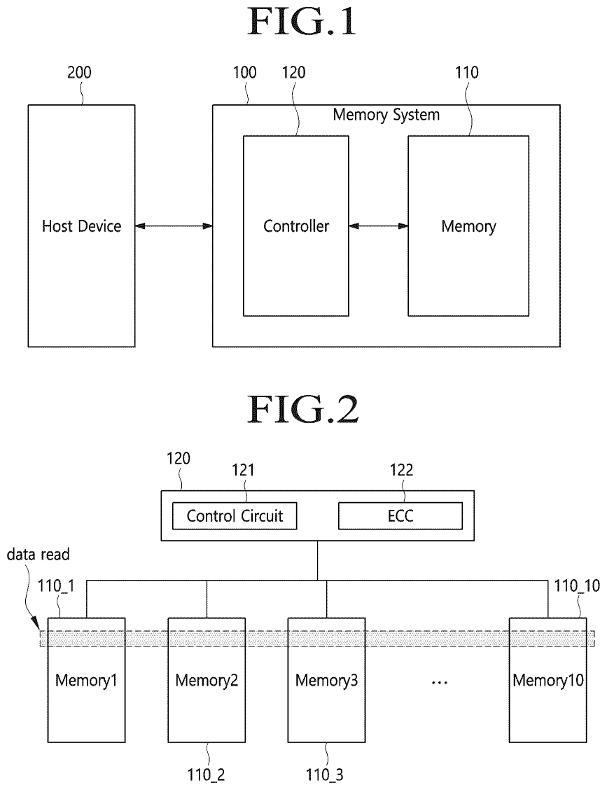

FIG. 1 is a diagram illustrating an example of the schematic configuration of a memory system 100 according to embodiments of the present disclosure.

Referring to FIG. 1, the memory system 100 according to the embodiments of the present disclosure may include at least one memory 110. The memory system 100 may include a controller 120 which controls the at least one memory 110.

The memory 110 may be, for example, volatile memory such as DRAM, SDRAM, DDR SDRAM and LPDDR SDRAM, but the memory 110 according to the embodiments of the present disclosure is not limited thereto. The memory 110 may be nonvolatile memory such as NAND flash memory, 3D NAND flash memory and NOR flash memory. One part of the memory 110 included in the memory system 100 may be volatile memory, and the other part may be nonvolatile memory.

The memory 110 may be one of various types of memory such as resistive RAM, phase change memory, magnetoresistive memory, ferroelectric memory and spin transfer torque memory. As the case may be, the memory 110 may be processing-in-memory which includes a computation function or a data processing function. In this case, a logic circuit which performs a computation function, etc. may be disposed inside the memory 110, or a memory cell array itself of the memory 110 may be used for a computation function. Alternatively, a logic circuit which performs a computation function, etc. may be located adjacent to the memory 110 outside the memory 110, and may perform a computational function, etc. based on a request from an external device.

The controller 120 may control the operation of the memory 110 on the basis of a command received from the external device or an internal command. For example, the controller 120 may control an operation of writing data to the memory 110 or reading data written to the memory 110. Alternatively, the controller 120 may be disposed separately from a memory controller which directly controls the write/read operation of the memory 110, and thereby, may perform various control on the memory 110 or perform processing or management on data stored in the memory 110.

The controller 120 may control the operation of the memory 110 while communicating with a device located outside the memory system 100. The memory system 100 may be, for example, a device which operates while communicating with an external device on the basis of the Compute Express Link (CXL) standard, and the controller 120 may perform control on the memory 110 while communicating with the external device according to the CXL standard. In this case, the controller 120 may also be referred to as a CXL controller by being distinguished from the aforementioned memory controller. The embodiments of the present disclosure may also be applied to the memory system 100 which communicates with an external device according to another interface, such as PCIe, other than the CXL standard.

The controller 120 may control the operation of the memory 110 according to a command and data received from a host device (i.e., an external device) 200 located outside the memory system 100.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, or the like. Alternatively, the host device 200 may be a virtual/augmented reality device which provides a 2D or 3D virtual reality image or augmented reality image. In addition to the examples described above, the host device 200 may be any one of various electronic devices which require the memory system 100 capable of storing data for data processing.

The host device 200 may include at least one operating system. The operating system may manage and control overall functions and operations of the host device 200, and may control an interoperation between the host device 200 and the memory system 100. The operating system may be classified into a general operating system and a mobile operating system depending on the mobility of the host device 200.

The host device 200 and the controller 120 may be devices which are separated from each other. As the case may be, the controller 120 and the host device 200 may be implemented by being incorporated as one device. In this case, the function of the controller 120 may be implemented by being included in the host device 200, and the memory system 100 may include only a memory controller which controls the direct operation of the memory 110. In the following, for the sake of convenience in explanation, a case where the controller 120 is disposed in the memory system 100 separately from the host device 200 will be described as an example, but the embodiments of the present disclosure are not limited thereto.

The controller 120 of the memory system 100 may perform an operation of writing data to the memory 110 or reading data written to the memory 110 according to a request from the host device 200. When the memory system 100 includes a plurality of memories 110, the controller 120 may provide, to the host device 200, result data based on data read from the plurality of memories 110 according to a read request from the host device 200.

The data read from the plurality of memories 110 may include user data to be used by the host device 200, and may also include parity data for correcting an error when the error occurs in the read data. When an error occurs in the data read from the plurality of memories 110, the controller 120 may detect and correct the error and provide error-corrected data to the host device 200. Error correction may be performed by a circuit located inside or outside the controller 120 of the

### Memory System 100

FIG. 2 is a diagram illustrating an example of the configuration of the controller 120 included in the memory system 100 according to the embodiments of the present disclosure and an example of a method of performing a data read operation in the memory system 100.

Referring to FIG. 2, the memory system 100 may include a plurality of memories 110_1, . . . , 110_10 and the controller 120. FIG. 2 illustrates as an example a case where the memory system 100 includes ten memories 110, such as a first memory 110_1, a second memory 110_2, . . . , a tenth memory 110_10, but the embodiments of the present disclosure are not limited thereto.

The controller 120 may include, for example, a control circuit 121 and an error correction circuit (ECC) 122.

The control circuit 121 may control the overall operations of the controller 120 and may perform control of the memory 110. The control circuit 121 may control a write operation, a read operation, etc. of data for the memory 110. Depending on the type of the memory 110, the control circuit 121 may control a refresh operation for the memory 110 or an operation of erasing data written to the memory 110. As the case may be, the control circuit 121 may test the performance of the memory 110 as a background operation during an idle period, or may control various operations for optimizing the memory 110.

The error correction circuit 122 may perform, when a read operation by the control circuit 121 is performed, an operation of detecting and correcting an error which occurs in the read operation. When detecting an error detected in the read operation, the error correction circuit 122 may provide information on the corrected error to the control circuit 121 or the host device 200. When a detected error cannot be corrected, the error correction circuit 122 may provide information on the uncorrectable error. The error correction circuit 122 may correct an error using an error correction algorithm, such as, for example, the Reed-Solomon algorithm, but the embodiments of the present disclosure are not limited thereto.

The controller 120 may perform a data read operation on a plurality of memories 110 according to a request from the host device 200.

For example, the controller 120 may read data having a unit size from each of the plurality of memories 110. The unit size may be, for example, 8 bytes, but is not limited thereto.

The controller 120 may read data having the unit size from each of all the memories 110 included in the memory system 100, and may provide result data based on read data to the host device 200.

At least a part of data read from the memories 110 included in the memory system 100 may be user data to be used by the host device 200. At least another part of the read data may be parity data to be used for error correction when an error occurs in the read data. In addition, the read data may include metadata including various management information associated with the user data or the memory 110.

The size of parity data included in data read from the memories 110 when the read data includes metadata may be smaller than the size of parity data included in read data when the read data does not include metadata. For example, the size of parity data may be smaller than two times the unit size. When the size of parity data is smaller than two times the unit size, an error occurred in user data read from the respective memories 110 may not be corrected according to the error correction algorithm.

In addition, due to lack of parity data, error correction may be difficult when a memory 110 which has a defect occurs among the plurality of memories 110. In this case, by performing a data read operation through specifying a memory 110 which has a defect, an error may be corrected using a small number of parity data. The embodiments of the present disclosure may provide measures for improving the error correction performance and reliability of the memory system 100 by increasing the accuracy of detecting a memory 110 which has a defect when the memory 110 which has a defect occurs in the memory system 100.

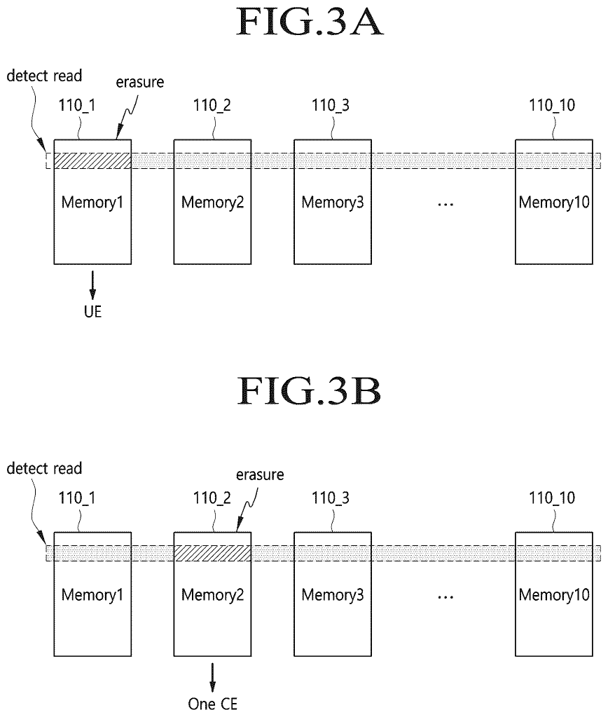

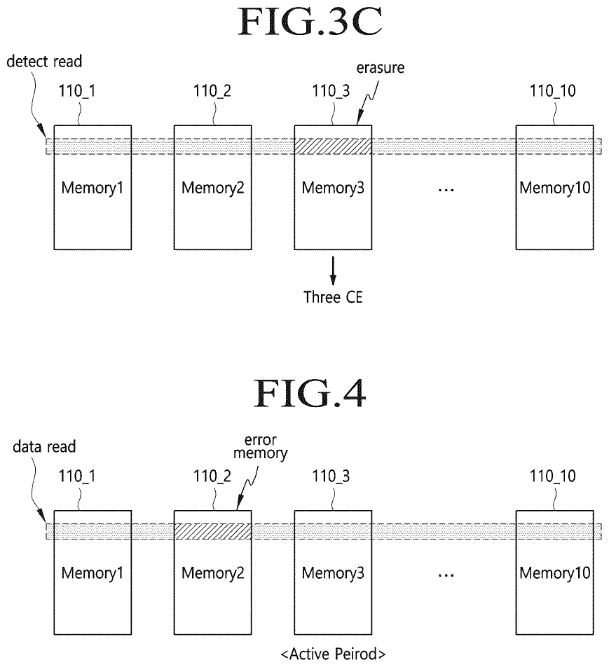

FIGS. 3A to 3C are diagrams illustrating examples of a method of performing a detect read operation in the memory system 100 according to the embodiments of the present disclosure.

Referring to FIG. 3A, the controller 120 of the memory system 100 may perform a data read operation of reading data from the plurality of memories 110 included in the memory system 100 according to a request from the host device 200. In the present specification, the data read operation may be referred to as a first read operation.

The controller 120 may read data having the unit size from each of the plurality of memories 110. As described above, the read data may include user data, metadata, parity data, etc.

The controller 120 may provide the read data to the host device 200. When an error occurs in the read data, the controller 120 may correct the error using the parity data. When the error cannot be corrected using the parity data, the controller 120 may recognize that an uncorrectable error has occurred. In the present specification and drawings, an uncorrectable error which cannot be corrected using parity data included in read data may be denoted by “UE.” The controller 120 may notify the host device 200 of that an uncorrectable error has occurred.

When an uncorrectable error occurs, the controller 120 may perform a detect read operation of detecting a memory 110 which has a defect among the plurality of memories 110. In the present specification, the detect read operation may also be referred to as a second read operation.

The controller 120 may perform a detect read operation of reading data having the unit size from each of remaining memories 110 excluding at least one memory 110 among the plurality of memories 110. In the present specification, excluding a memory 110 during a detect read operation may be mentioned as applying erasure. The controller 120 may perform a detect read operation by applying erasure, and may check whether an error occurs in the detect read operation.

For example, referring to FIG. 3A, the controller 120 may perform a detect read operation of reading data from remaining memories 110 excluding the first memory 110_1 among the plurality of memories 110. The controller 120 may perform the detect read operation by applying erasure to the first memory 110_1.

The controller 120 may read data having the unit size from each of the remaining memories 110 excluding the first memory 110_1. The controller 120 may check whether an error occurs in data read from the remaining memories 110.

When the controller 120 performs the detect read operation on the remaining memories 110 excluding the first memory 110_1, an uncorrectable error may occur. Since an uncorrectable error occurs in the detect read operation excluding the first memory 110_1, the controller 120 may recognize that a memory 110 which has a defect exists among the memories 110 other than the first memory 110_1.

The controller 120 may perform a detect read operation by apply erasure to a memory 110 other than the first memory 110_1.

For example, referring to FIG. 3B, the controller 120 may perform a detect read operation of reading data from remaining memories 110 excluding the second memory 110_2 among the plurality of memories 110. The controller 120 may read data having the unit size from each of the remaining memories 110 excluding the second memory 110_2. The controller 120 may check whether an error occurs in the detect read operation excluding the second memory 110_2.

When an error occurs in the detect read operation excluding the second memory 110_2, the error may not be correctable by the controller 120. Alternatively, an error which occurs in the detect read operation may be correctable by the controller 120. When an error which occurs in the detect read operation is correctable, the controller 120 may check the number of corrected errors. In the present specification and drawings, when an error which occurs in a detect read operation is corrected, the error corrected in the corresponding operation may be denoted by “CE.” “CE” may mean an error which is corrected by the controller 120, and when an error is not correctable by the controller 120, the error may be an uncorrectable error “UE.”

For example, as in the example illustrated in FIG. 3B, the number of errors CE corrected in the detect read operation performed excluding the second memory 110_2 may be 1.

Since an uncorrectable error occurs in the detect read operation excluding the first memory 110_1 and the error occurred in the detect read operation excluding the second memory 110_2 is correctable, the controller 120 may regard (i.e., set) the second memory 110_2 as an error memory or an error device.

When the second memory 110_2 is a memory 110 which has a defect, a correctable error may occur only in the detect read operation excluding the second memory 110_2, and an uncorrectable error may occur in each of all remaining detect read operations. The controller 120 may set the second memory 110_2 as an error memory or an error device.

Alternatively, an uncorrectable error may not occur due to the configuration of read data or wrong recognition of data in a detect read operation. In this case, detection of an error memory may not be performed accurately. Even in the case where a number of corrected errors is checked in the detect read operation excluding the second memory 110_2, the controller 120 may determine an error memory by performing detect read operations after applying erasure to the remaining memories 110.

For example, referring to FIG. 3C, after performing the detect read operation by applying erasure to the second memory 110_2, the controller 120 may perform a detect read operation by reading data from remaining memories 110 excluding the third memory 110_3 among the plurality of memories 110.

The controller 120 may read data having the unit size from each of the remaining memories 110 excluding the third memory 110_3. The controller 120 may check whether an error is detected in data read from the memories 110 other than the third memory 110_3.

The controller 120 may check that an uncorrectable error occurs in the detect read operation performed on the memories 110 other than the third memory 110_3. Alternatively, the controller 120 may detect an error and correct the detected error in the detect read operation performed on the memories 110 other than the third memory 110_3.

The controller 120 may check the number of errors corrected in the detect read operation performed on the memories 110 other than the third memory 110_3. The number of errors corrected in the detect read operation performed on the memories 110 other than the third memory 110_3 may be different from the number of errors corrected in the detect read operation performed on the memories 110 other than the second memory 110_2. For example, the number of errors CE corrected in the detect read operation performed on the memories 110 other than the third memory 110_3 may be 3.

The controller 120 may sequentially perform detect read operations in each of which remaining memories 110 excluding one memory 110 among the plurality of memories 110 are used. The controller 120 may check the number of errors corrected in each detect read operation. The controller 120 may recognize, as a memory 110 which has a defect, a memory 110 excluded in a detect read operation in which the number of corrected errors is smallest among the detect read operations.

For example, when the number of errors corrected in the detect read operation excluding the second memory 110_2 is 1 and the number of errors corrected in a detect read operation excluding any one of the remaining memories 110 is greater than 1, the second memory 110_2 may be set as an error memory.

In a case where an error is corrected instead of being recognized as an uncorrectable error due to wrong recognition of data read in a detect read operation, etc., the number of corrected errors may probabilistically increase. Therefore, when a plurality of cases in each of which an error is correctable occur in a plurality of detect read operations, a memory 110 excluded in a case where the number of corrected errors is smallest among the plurality of detect read operations may be highly likely to be a memory 110 which has a defect.

When the plurality of cases in each of which an error is correctable are checked in the plurality of detect read operations, the controller 120 may set, as an error memory 110, a memory 110 excluded in a case where the number of corrected errors is smallest among the plurality of detect read operations, thereby increasing the accuracy of detecting a memory 110 which has a defect.

When setting an error memory 110, the controller 120 may transmit an error memory setting notification signal to the host device 200. The host device 200 may request a write operation or a read operation for data to the memory system 100 on the basis of the setting information of the error memory 110.

Alternatively, as the case may be, the number of errors corrected in the detect read operation performed on the memories 110 other than the third memory 110_3 may be the same as the number of errors corrected in the detect read operation performed on the memories 110 other than the second memory 110_2. In this case, the controller 120 may regard that it is a state in which a memory 110 which has a defect cannot be detected, and may end a detect read operation or perform a detect read operation again.

Through the above-described procedure, the controller 120 may accurately detect a memory 110 which has a defect among the plurality of memories 110, and may perform a read operation on the plurality of memories 110 while recognizing the memory 110 which has a defect. Even when a memory 110 which has a defect is included in the plurality of memories 110, the controller 120 may perform error correction using parity data, and may improve the operational performance and reliability of the memory system 100.

FIG. 4 is a diagram illustrating an example of a method of performing a data read operation after setting an error memory in the memory system 100 according to the embodiments of the present disclosure.

Referring to FIG. 4, as in the examples described above through FIGS. 3A to 3C, when an uncorrectable error occurs in the process of reading data from all of the plurality of memories 110 included in the memory system 100, the controller 120 of the memory system 100 may perform an operation of searching for an error memory.

Through the operation of searching for an error memory, the controller 120 may set, as an error memory, the second memory 110_2 which is excluded when the number of errors corrected in a detect read operation is smallest. When performing a data read operation after setting an error memory, the controller 120 may perform the data read operation by excluding the error memory from the plurality of memories 110.

For example, as in an example illustrated in FIG. 4, according to a request from the host device 200, the controller 120 may perform a data read operation by applying erasure to the second memory 110_2 which is an error memory among the plurality of memories 110, during an active period in which a data read operation for the memories 110 is controlled.

The controller 120 may read data having the unit size from each of the remaining memories 110 excluding the second memory 110_2 among the plurality of memories 110. The controller 120 may read data having the unit size from each of the remaining memories 110 excluding the second memory 110_2, and may provide result data according to the request to the host device 200 on the basis of read data.

The controller 120 may set an error memory, may perform a data read operation on remaining memories 110, and may perform an operation of correcting an error when an error occurs, using parity data read from the remaining memories 110.

When an uncorrectable error occurs in the process of performing a data read operation after setting an error memory, the controller 120 may set an error memory again. For example, when an uncorrectable error occurs in a data read operation performed within a predetermined period after setting an error memory, the controller 120 may recognize that the setting of the error memory is wrong, and may perform an operation of searching an error memory again.

The controller 120 may perform a test read operation on an error memory at a preset time or during a preset period after setting the error memory, and may determine whether to search for an error memory again.

For example, when setting an error memory by searching for a memory 110 which has a defect among the plurality of memories 110, the controller 120 may set the value of a background test register to a first value. When the value of the background test register is set to the first value, the controller 120 may perform a test read operation on the error memory at a preset time or during a preset period. The controller 120 may perform a test read operation, for example, during a period in which control on the memories 110 according to a request from the host device 200 is not performed.

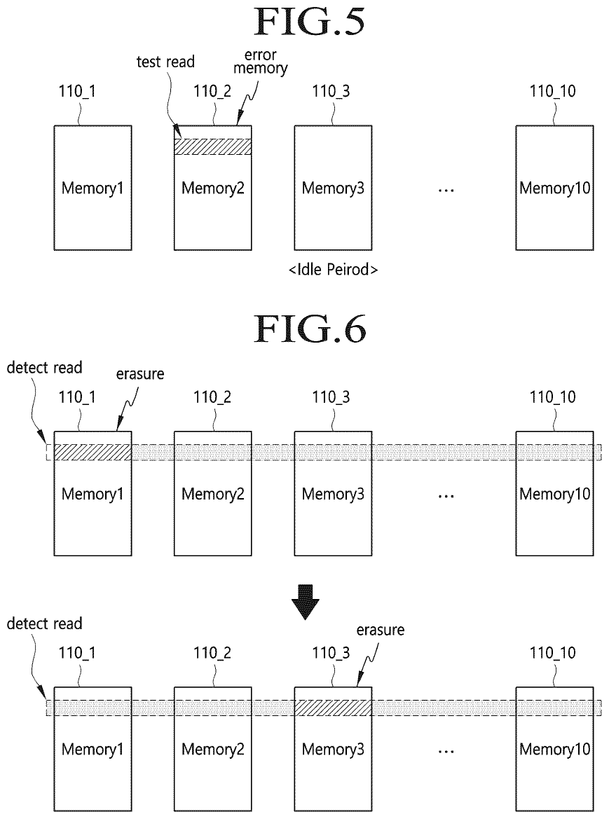

FIG. 5 is a diagram illustrating an example of a method of performing a test read operation after setting an error memory in the memory system 100 according to the embodiments of the present disclosure.

Referring to FIG. 5, the controller 120 may set the value of the background test register to the first value after setting the second memory 110_2 as an error memory.

During a period in which the value of the background test register is set to the first value, as in the example described above through FIG. 4, the controller 120 may perform a data read operation on the remaining memories 110 excluding the second memory 110_2 which is set as an error memory.

When an uncorrectable error does not occur in the data read operation, the controller 120 may control the operations of the memories 110 while maintaining the setting of the error memory.

The controller 120 may perform a test read operation on the second memory 110_2 which is set as an error memory, during a predetermined period of the period in which the value of the background test register is set to the first value. For example, the controller 120 may perform a test read operation on the second memory 110_2 during an idle period. In the present specification, the test read operation may be referred to as a third read operation.

The controller 120 may check whether an error is detected in the test read operation for the second memory 110_2. The controller 120 may correct an error which is detected in test read operation. The controller 120 may check the number of errors which are corrected in the test read operation.

When the number of errors which are corrected in the test read operation for the second memory 110_2 is equal to or greater than a preset number, the controller 120 may recognize that setting of the error memory is performed normally. The controller 120 may perform a data read operation during an active period in a state in which the second memory 110_2 is set as an error memory.

When a specific period in which a test read operation is possible, such as an idle period, occurs during a period in which the value of the background test register is set to the first value, the controller 120 may perform a test read operation and verify the setting of the error memory.

When it is checked in a predetermined number of test read operations or a test read operation performed within a predetermined period after the error memory is set that the second memory 110_2 set as the error memory has failed (or has a defect), the controller 120 may change the value of the background test register from the first value to a second value.

When the value of the background test register is set to the second value, the controller 120 may not perform a test read operation on the error memory.

The controller 120 may perform a data read operation excluding the second memory 110_2 which is set as an error memory.

When an uncorrectable error occurs in a data read operation performed in a state in which the value of the background test register is changed and set to the second value, the controller 120 may skip an operation of searching for an error memory since it may be regarded that at least two memories 110 among the plurality of memories 110 included in the memory system 100 have failed (or have a defect).

When the number of errors which are corrected in a test read operation for the second memory 110_2 is smaller than a preset number, the controller 120 may recognize that the setting for the error memory is wrong.

The controller 120 may perform a detect read operation to set an error memory again. While performing the detect read operation again, the controller 120 may maintain the value of the background test register as the first value. Alternatively, the controller 120 may change the value of the background test register to the second value or a default value, and may perform a detect read operation again.

FIG. 6 is a diagram illustrating an example of a method of performing a detect read operation after performing a test read operation in the memory system 100 according to the embodiments of the present disclosure.

Referring to FIG. 6, when the number of errors which are corrected in a test read operation for the second memory 110_2 set as an error memory among the plurality of memories 110 included in the memory system 100 is smaller than a preset number, the controller 120 may perform a detect read operation for setting an error memory again.

For example, the controller 120 may perform a detect read operation on remaining memories 110 excluding the first memory 110_1 among the plurality of memories 110. The controller 120 may perform a detect read operation on remaining memories 110 excluding the third memory 110_3 among the plurality of memories 110.

The controller 120 may perform detect read operations using remaining memories 110 excluding sequentially the memories 110 other than the second memory 110_2.

The controller 120 may check the number of errors which are corrected in each detect read operation. The controller 120 may set, as an error memory, a memory 110 which is excluded when the number of errors corrected during a detect read operation is smallest.

After setting the error memory, the controller 120 may perform a data read operation on memories 110 other than the error memory. The controller 120 may set to the first value or maintain the value of the background test register. The controller 120 may perform a test read operation on the error memory at a preset time or during a preset period, and depending on the result of the test read operation, may perform a detect read operation again or change the value of the background test register to the second value.

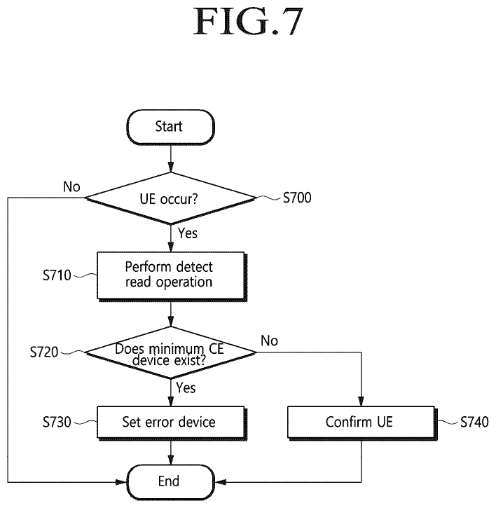

FIG. 7 is a diagram illustrating an example of a method in which the memory system 100 according to the embodiments of the present disclosure sets an error memory.

Referring to FIG. 7, the memory system 100 may check occurrence of an uncorrectable error UE during a data read operation performed on a plurality of memories 110 included in a memory system 100 (S700).

The memory system 100 may read data having a unit size from each of the plurality of memories 110, and may check whether an error occurred in read data is correctable.

When an uncorrectable error occurs, the memory system 100 may perform a detect read operation for detecting an error memory or an error device (S710). The memory system 100 may sequentially perform an operation of reading data from remaining memories 110 excluding each of the plurality of memories 110 in a detect read operation.

The memory system 100 may check the number of corrected errors CE in each detect read operation and check whether there is a case where the number of corrected errors CE is minimum (S720).

When there is a case where the number of corrected errors CE is minimum (i.e., “Yes” in S720), the memory system 100 may set a memory 110 which is excluded in a detect read operation where the number of corrected errors CE is minimum, as an error memory or an error device (S730).

When there is not a case where the number of corrected errors CE is minimum and there are at least two detect read operations with the same number of corrected errors CE (i.e., “No” in S720), the memory system 100 may regard that an uncorrectable error UE has occurred (S740). In this case, the memory system 100 may end searching for an error device or perform a detect read operation for searching for an error device again.

When setting an error memory, the memory system 100 may provide information on setting of the error memory to the host device 200.

After an error memory is set, the memory system 100 may control a read operation for the plurality of memories 110 by considering the setting of the error memory.

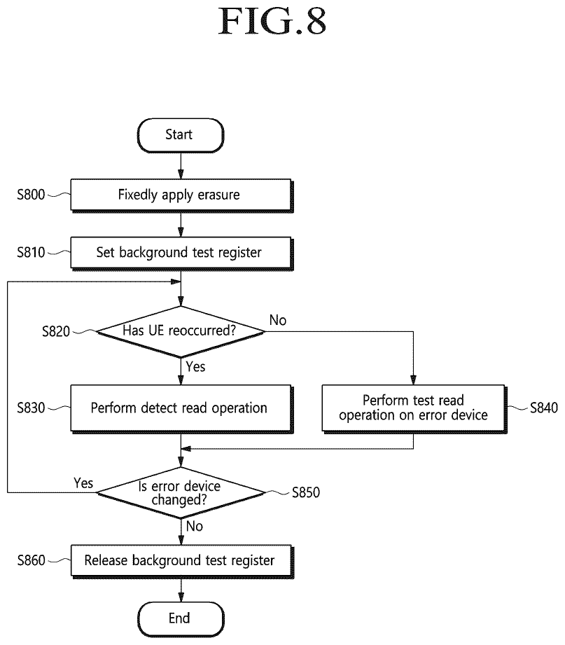

FIG. 8 is a diagram illustrating an example of a method in which the memory system 100 according to the embodiments of the present disclosure operates after setting an error memory.

Referring to FIG. 8, when an error memory is set, the memory system 100 may fixedly apply erasure to the error memory (S800). The memory system 100 may perform a data read operation on remaining memories 110 excluding the error memory.

When the error memory is set, the memory system 100 may set the value of a background test register to a first value (S810).

In a state in which the error memory is set and the value of the background test register is set to the first value, the memory system 100 may perform a data read operation. The memory system 100 may check whether an uncorrectable error UE occurs in the data read operation performed after setting of the error memory (S820).

When an uncorrectable error UE occurs (i.e., “Yes” in S820), the memory system 100 may perform an operation of searching for an error device again (S830).

When an uncorrectable error UE does not occur (i.e., “No” in S820), the memory system 100 may perform a test read operation of testing the error device during a preset period such as an idle period or at a preset time (S840).

The memory system 100 may check whether an error device is changed (S850). When the error device is changed through searching for an error device again or testing the error device (i.e., “Yes” in S850), the memory system 100 may perform a data read operation on remaining memories 110 excluding the error device in a state where the error device is set to be changed. The memory system 100 may perform an operation of re-setting an error device or testing an error device depending on whether an uncorrectable error UE occurs (S820).

When the error device is not changed as a result of testing the error device (i.e., “No” in S850), the memory system 100 may set the value of the background test register to a second value (S860). That is, the memory system 100 may release background test register. After releasing the background test register, the memory system 100 may not perform an operation for searching an error device again.

When an uncorrectable error UE occurs in a state in which the background test register is released, the memory system 100 may not perform an operation of searching for an error device and may regard that an uncorrectable error UE has occurred.

According to the embodiments of the present disclosure described above, when a memory 110 which has a defect occurs in the memory system 100 including the plurality of memories 110, the accuracy of detecting the memory 110 which has a defect may be increased, and thus, even when the memory 110 which has a defect is included, the operational performance of the memory system 100 may be improved.

In addition, even when parity data is insufficient through accurate detection of the memory 110 which has a defect, error correction performance may be improved, whereby it is possible to improve the operational performance and reliability of the memory system 100.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A memory system comprising:
a plurality of memories; and
a controller configured to
perform a data read operation of reading data having a unit size from each of the plurality of memories,
perform, when an uncorrectable error occurs during the data read operation, detect read operations, each detect read operation reading data having the unit size from each of remaining memories excluding at least one memory selected in rotation among the plurality of memories,
check numbers of errors corrected in each of the detect read operations, and
set, as an error memory, at least one memory excluded in a detect read operation in which a smallest number of errors is corrected, among the detect read operations.

2. The memory system according to claim 1, wherein the controller is configured to set a value of a background test register to a first value when the error memory is set, and perform a test read operation on the error memory.

3. The memory system according to claim 2, wherein the controller is configured to:
perform, during a period in which the value of the background test register is set to the first value, the data read operation on remaining memories excluding the error memory among the plurality of memories; and
reset an error memory when the uncorrectable error occurs in the data read operation.

4. The memory system according to claim 2, wherein the controller is configured to reset an error memory when a number of errors detected in the test read operation is smaller than a preset number.

5. The memory system according to claim 2, wherein when a number of errors detected in the test read operation is equal to or greater than a preset number are, the controller is configured to set the value of the background test register to a second value without performing the test read operation.

6. The memory system according to claim 5, wherein the controller is configured to:
perform, during a period in which the value of the background test register is set to the second value, the data read operation on remaining memories excluding the error memory among the plurality of memories; and
skip an operation of searching for an error memory when the uncorrectable error occurs in the data read operation.

7. The memory system according to claim 1,
wherein when the uncorrectable error occurs in the data read operation for the plurality of memories, the controller is configured to:
perform a first detect read operation on remaining memories excluding a first memory among the plurality of memories; and
perform a second detect read operation on remaining memories excluding a second memory among the plurality of memories, and compares a number of errors corrected in the first detect read operation with a number of errors corrected in the second detect read operation when the uncorrectable error does not occur in the first detect read operation and the second detect read operation.

8. The memory system according to claim 7, wherein the number of errors corrected in the first detect read operation is different from the number of errors corrected in the second detect read operation.

9. The memory system according to claim 7, wherein when a number of errors corrected in the first detect read operation and a number errors corrected in the second detect read operation are identical to each other and corresponds to the smallest number of errors, the controller is configured to notify an external device of that the uncorrectable error has occurred.

10. The memory system according to claim 1, wherein when the error memory is set, the controller is configured to perform the data read operation on the remaining memories excluding the error memory among the plurality of memories.

11. The memory system according to claim 1, wherein when the error memory is set, the controller is configured to transmit an error memory setting notification signal to an external device.

12. The memory system according to claim 1,
wherein data read from the plurality of memories includes user data, metadata and parity data, and
wherein a size of the parity data is smaller than two times the unit size.

13. A memory system comprising:
a plurality of memories; and
a controller configured to
perform a data read operation on remaining memories excluding an error memory, among the plurality of memories,
perform a test read operation on the error memory, and
sequentially perform detect read operations on memories other than one memory selected in rotation among the plurality of memories when a number of errors detected in the test read operation is smaller than a preset number.

14. The memory system according to claim 13, wherein the controller is configured to skip performing the detect read operations on the error memory.

15. The memory system according to claim 13, wherein the controller is configured to:
perform a first detect read operation on memories other than a first memory among the plurality of memories;
perform a second detect read operation on memories other than a second memory among the plurality of memories, and compares a number of errors corrected in the first detect read operation with a number of errors corrected in the second detect read operation when an uncorrectable error does not occur in the first detect read operation and the second detect read operation.

16. The memory system according to claim 15, wherein the number of error corrected in the first detect read operation is different from the number of errors corrected in the second detect read operation.

17. The memory system according to claim 15, wherein when the number of errors corrected in the first detect read operation is smaller than the number of errors corrected in the second detect read operation, the controller is configured to set the first memory as a new error memory, and perform the data read operation on the memories other than the first memory.

18. The memory system according to claim 16, wherein the number of errors corrected in the first detect read operation is smallest among numbers of errors corrected in each of the detect read operations.

19. A controller comprising:
a control circuit configured to perform a first read operation on a plurality of memories; and
an error correction circuit configured to correct an error which occurs in the first read operation,
wherein the control circuit is configured to:
sequentially perform second read operations on memories excluding at least one memory selected in rotation among the plurality of memories when an uncorrectable error occurs in the first read operation, and
set, as an error memory, a memory which is excluded in a second read operation in which a smallest number of errors is corrected, among the second read operations.

20. The controller according to claim 19, wherein the control circuit is configured to perform the first read operation on memories excluding the error memory among the plurality of memories, and perform a third read operation on the error memory.
